(19) United States
(12) Patent Application Publication
(10) Pub. No.: US 2024/0342760 A1
(43) Pub. Date: Oct. 17, 2024

(54) ROTARY MECHANISM AND HANDHELD TOOL

(71) Applicants: ZHEJIANG PRULDE ELECTRIC APPLIANCE CO., LTD., Jinhua, Zhejiang (CN); BATAVIA B.V., Staphorst (NL)

(72) Inventors: Weiming YANG, Jinhua (CN); Raymond PAAIS, Staphorst (NL)

(73) Assignees: ZHEJIANG PRULDE ELECTRIC APPLIANCE CO., LTD., Jinhua, Zhejiang (CN); BATAVIA B.V., Staphorst (NL)

(21) Appl. No.: 18/684,905

(22) PCT Filed: Sep. 16, 2021
(86) PCT No.: PCT/CN2021/118735

§ 371 Date: Feb. 20, 2024

(30) Foreign Application Priority Data
Aug. 23, 2021 (CN) 202110966238.X

(51) Int. Cl. B08B 1/36; B08B 1/12

(52) U.S. Cl. CPC B08B 1/36; B08B 1/12

(57) ABSTRACT

A rotary mechanism and a handheld tool, which relates to mechanical regulation. The rotary mechanism including a first part, a second part, and a rotary locking assembly, a mounting portion being provided on the first part, the second part having a rotary portion adapted to the mounting portion; the rotary portion and the mounting portion are rotatably sleeving-fitted, the rotary locking assembly includes a sliding block and a rotary drive element, the sliding block is mounted on the rotary portion, and the rotary drive element rotates to bring the sliding block to move radially along the rotary portion so that the sliding block is locked on the mounting portion or is unlocked from the mounting portion.

### FIELD

The subject matter described herein relates to mechanical regulation, and more particularly relates to a rotary mechanism and a cleaning brush.

### BACKGROUND

A cleaning brush, for example, may be applied to clean vehicles, glass doors/windows, and courtyard pavements due to its high efficiency and convenience. The cleaning brush, particularly handheld cleaning brush, is highly favored due to its portability, light-weight, high flexibility, and friendly use in household scenarios. However, the hand grip and the brushing disc-mounted head of an existing handheld cleaning brush are fixed relative to each other, with the angle between the hand grip and the brushing disc being invariable, which affects service effect and user experience.

### SUMMARY

To overcome the above and other drawbacks in conventional technologies, a rotary mechanism facilitating adjustment and locking is provided.

A technical solution adopted by the disclosure is set forth infra:

A rotary mechanism, comprising a first part, a second part, and a rotary locking assembly, a mounting portion being provided on the first part, the second part having a rotary portion adapted to the mounting portion, wherein the rotary portion and the mounting portion are rotatably sleeving-fitted, the rotary locking assembly comprises a sliding block and a rotary drive element, the sliding block is mounted on the rotary portion, and the rotary drive element rotates to bring the sliding block to move radially along the rotary portion so that the sliding block is locked on the mounting portion or is unlocked from the mounting portion.

In some implementations, an inner gear ring is provided on the mounting portion, and outer teeth meshed with the inner gear ring are provided on the sliding block; or, the sliding block and the mounting portion are locked via friction fitting or pin-hole fitting.

In some implementations, a pushing surface is provided on the rotary drive element, and a force-receiving surface fitted with the pushing surface is provided on the sliding block, so that when the rotary drive element rotates, the pushing surface applies a pushing force against the force-receiving surface along a radial direction of the rotary portion.

In some implementations, the pushing surface has a gradually widened configuration on the rotary drive element along a rotate-to-unlock direction, so that when the rotary drive element rotates, the force-receiving surface is sliding-fitted or rolling-fitted with the gradually widened configuration; and/or, the pushing surface extends out along the rotate-to-unlock direction to form a pressing surface in tight pressing-fit with the force-receiving surface.

In some implementations, a stopper configured to limit a rotational travel of the pressing surface is provided along a rotate-to-lock direction on the force-receiving surface; or, the rotational travel of the pressing surface is limited by fitting between a flip lock lever and a bump.

In some implementations, the rotary drive element comprises a rotary cam, a convex rib being provided on the rotary cam, a side surface of the convex rib being formed as a pushing surface for pushing the sliding block.

In some implementations, at least three convex ribs are provided on the rotary cam, the at least three convex ribs being end-to-end connected to form a closed loop.

In some implementations, the rotary drive element further comprises a rotary flip lock lever sleeved over the rotary cam, the rotary flip lock lever driving the rotary cam to rotate.

In some implementations, the rotary flip lock lever comprises a driver portion and a rotation-transmitting portion sleeved over the convex rib, and a transmission block is provided on the rotation-transmitting portion, an inner side surface of the transmission block being agreeable with an outer side surface of the convex rib.

The disclosure offers the following benefits:

To overcome a drawback that the hand grip and head housing of an existing handheld cleaning brush are fixed relative to each other so that the angle therebetween is non-adjustable, the disclosure arranges the head housing as a first part and the hand grip as the second part to be rotatably sleeving-fitted, so that they may rotate relative to each other, thereby realizing adjustment of their relative positions; in addition, the rotary locking assembly as provided locks them to their adjusted positions. In need of adjustment, the rotary drive element is driven to rotate reversely, bringing the sliding block to move on the rotary portion radially along a center of the rotary portion, whereby unlocking is realized. After the first part rotates relative to the second part till an appropriate angle, the rotary drive element is driven to rotate forwardly, bringing the sliding block to move on the rotary portion radially towards an edge of the rotary portion so as to gradually approach the mounting portion, till being engaged and locked with the mounting portion, whereby the first part and the second part are locked there.

The rotary mechanism disclosed herein realizes locking and unlocking at different positions via radial sliding of the sliding block on the rotary portion, which simplifies the structure and facilitates operation; in addition, the relative positions between the first part and the second part are multi-stage or stepless adjustable dependent on different use scenarios, so that the brushing disc is more conformable with the to-be-cleaned surface, which also facilitates force application by hand, enhances cleaning effect, and improves user experience.

With the inner gear ring provided on the mounting portion and outer teeth meshed with the inner gear ring provided on the sliding block, the outer teeth of the sliding lock can be locked at any position of the inner gear ring, which realizes stepless adjustment between the first part and the second part. Tooth-fitting locking is easily implemented with a lower fitting precision requirement; in addition, the pluralities of teeth are restrictive to each other, rendering secure locking. The sliding block and the mounting portion are locked via friction fitting or pin-hole fitting; this friction locking or pin-hole fitting lock simplifies the structure and eases manufacturing.

With the pushing surface provided on the rotary drive element and the force-receiving surface fitted with the pushing surface provided on the sliding block, when the rotary drive element rotates, the pushing surface applies a pushing force against the force-receiving surface along the radial direction of the rotary portion, and the force applied by the pushing surface against the force-receiving surface enables the rotary drive element to drive the sliding block to move radially.

The pushing surface has a gradually widened configuration on the rotary drive element along a rotate-to-unlock direction, so that when the rotary drive element rotates, the force-receiving surface and the gradually widened configuration are sliding-fitted or rolling-fitted; with this gradually widened structural profile, when the rotary drive element rotates forwardly, the force-receiving surface slides on the pushing surface along the gradually widened direction, so that the pushing surface pushes the force-receiving surface outwardly, causing the sliding block to move towards the edge of the rotary portion till being locked; when the rotary drive element rotates reversely, the force-receiving surface slides on the pushing surface along a gradually narrowed direction, so that the pushing surface brings the force-receiving surface to move inwardly, causing the sliding block to move towards the center of the rotary portion till being unlocked.

The pushing surface extends out along the rotate-to-unlock direction to form a pressing surface in tight pressing-fit with the force-receiving surface; the pressing surface presses against the force-receiving surface to cause the sliding block to securely and tightly abut against the mounting portion, whereby locking between the first part and the second part is realized.

By providing the stopper for restraining the rotational travel of the pressing surface on the force-receiving surface along the rotate-to-lock direction, when the rotary drive element rotates forwardly, the pressing surface can only rotate to a position corresponding to the force-receiving surface, unable to rotate further, whereby secure locking between the sliding block and the mounting portion is realized.

The rotary drive element comprises a rotary cam, the convex rib is provided on the rotary cam, and the side surface of the convex rib is formed as a pushing surface for pushing the sliding block; fitting between the convex rib and the sliding block converts rotation of the cam to radial movement of the sliding block on the rotary portion; in addition, the tangent line of the circumferential rotational trajectory of the convex rib at the sliding block position is vertical to the radial direction, so that by rotating the convex rib, the radial movement of the sliding block can be restrained, thereby realizing locking between the sliding block and the mounting portion. When the rotary cam rotates forwardly, the sliding block moves towards the edge of the rotary portion, with the elastic reset element being stretched in the meanwhile, so that when the rotary cam rotates reversely, the elastic reset element is reset gradually, and the sliding block, pulled by the elastic reset element, moves towards the center of the rotary portion till resuming its initial position.

By providing at least three convex ribs on the rotary cam, the at least three convex ribs being end-to-end connected to form a closed loop, synchronous locking at multiple positions in the circumferential direction is realized, rendering more secure locking; in addition, the end-to-end joints may also restrain the relative sliding travel of the convex rib.

The rotary drive element further comprises a rotary flip lock lever sleeved over the rotary cam, the rotary flip lock lever driving the rotary cam to rotate; the rotary flip lock lever as provided facilitates force application by hand and rotational travel control.

The rotary flip lock lever comprises a driver portion and a rotation-transmitting portion sleeved over the convex rib, and a transmission block is provided on the rotation-transmitting portion, an inner side surface of the transmission block being agreeable with an outer side surface of the convex rib; in this way, fitting between the rotary plate and the convex rib is realized; the driver portion pushes the rotary flip lock lever to rotate, and the rotation-transmitting portion transmits a rotational torque of the rotary flip lock lever to the convex rib of the rotary cam via the transmission block, bringing the rotary cam to rotate.

Another technical solution adopted by the disclosure is set forth infra:

A handheld tool, comprising the rotary mechanism stated in any of the above technical solutions.

In some implementations, the handheld tool comprises a housing and a hand grip, a mounting portion being provided on the housing, the hand grip having a rotary portion adapted to the mounting portion.

These and other features and advantages of the disclosure will be described in detail through the example embodiments in conjunction with the drawings.

### BRIEF DESCRIPTION OF THE DRAWINGS

Hereinafter, the disclosure will be further illustrated in conjunction with the accompanying drawings:

FIG. 1 is a stereoscopic structural diagram of a cleaning brush according to the disclosure.

FIG. 2 is an exploded view of the cleaning brush according to the disclosure;

FIG. 3 is a structural schematic diagram of fitting between a rotary cam and a hand grip rotary portion in a locked state according to the disclosure;

FIG. 4 is a structural schematic diagram of fitting between the rotary cam and the hand grip rotary portion in an unlocked state according to the disclosure;

FIG. 5 is a stereoscopic structural view of a rotary locking assembly according to the disclosure;

FIG. 6 is a stereoscopic structural view of a rotary flip lock lever according to the disclosure;

FIG. 7 is a stereoscopic structural view of a rotary cam according to the disclosure;

FIG. 8 is a stereoscopic structural view of a sliding block according to the disclosure.

### REFERENCE NUMERALS

cleaning brush 001;
brushing disc 1;
housing 2; mounting portion 201; inner gear ring 2011; inner cavity 2012; mounting shaft 2013; fastening hole 2013a;
hand grip 3; rotary portion 301; annular-shaped shroud 3011; recessed groove 3012;
guide rail 3013;
sliding block 4; force-receiving surface 401; outer teeth 402;
rotary drive element 5; rotary cam 501; convex rib 5011; notch 5012; pushing surface 5011a; pressing surface 5011b; faceplate 5013; through hole 5014; vertical rib 5015; rotary flip lock lever 502; driver portion 5021; rotation-transmitting portion 5022; transmission block 5023; transmission block inner side surface 5023a;
elastic reset element 6.

### DETAILED DESCRIPTION OF EMBODIMENTS

Hereinafter, the technical solutions of the disclosure will be explained and illustrated through embodiments with reference to the accompanying drawings. However, the embodiments are only preferred embodiments of the disclosure, not all of them. Other embodiments derived by those skilled in the art without exercise of inventive work based on the examples in the embodiments all fall within the protection scope of the disclosure.

In the description of the disclosure, it needs to be understood that the orientational or positional relationships indicated by the terms “center,” “longitudinal,” “transverse,” “length,” “width,” “thickness,” “upper,” “lower,” “front,” “rear,” “left,” “right,” “vertical,” “horizontal,” “top,” “bottom,” “inner,” “clockwise,” and “counterclockwise” refer to those orientational and positional relationships illustrated in the drawings, which are intended only for facilitating description of the disclosure and simplifying relevant depictions, but not for indicating or implying that the devices or elements compulsorily possess such specific orientations or are compulsorily configured and operated with the specific orientations; therefore, such terms should not be construed as limitations to the disclosure.

Besides, the terms “first” and “second” are only used for descriptive purposes, which shall not be construed as indicating or implying relative importance or implicitly indicating the number of a referred to technical feature. Therefore, the features limited by “first” and “second” may explicitly or implicitly include one or more of such features. In the description of the present disclosure, unless otherwise indicated, “plurality” indicates two or above.

In the disclosure, unless otherwise explicitly provided and limited, the terms such as “mount,” “connect,” “couple,” and “fix” should be understood broadly, which, for example, may refer to a fixed connection, a detachable connection, or an integrated connection; which may be a mechanical connection or an electrical connection; which may be a direct connection or an indirect connection via an intermediate medium; which may also be a communication between the insides of two elements. To a person of normal skill in the art, specific meanings of the above terms in the disclosure may be construed based on specific situations.

In the disclosure, unless otherwise explicitly provided and limited, an expression that a first feature is “above” or “below” a second feature may refer to a direct contact between the first feature and the second feature or may refer to a scenario where although the first feature and the second feature do not contact directly, they contact via a further feature therebetween. Moreover, the expression that the first feature is “above” or “over” or “on” the second feature refers to a situation where the first feature is exactly or generally over the second feature or only refers to a situation that the horizontal height of the first feature is higher than the second feature. The expression that the first feature is “under” or “below” or “beneath” the second feature refers to a situation where the first feature is exactly or generally below the second feature or only refers to a situation that the horizontal height of the first feature is lower than the second feature.

Hereinafter, the rotary mechanism according to the disclosure will be described in further detail through example implementations with reference to the accompanying drawings.

Now, the disclosure will be explained with a cleaning brush 001 as an example, however, those skilled in the art would appreciate that, the disclosure may also be applied to other devices or apparatuses with a rotary mechanism, particularly a handheld tool.

Referring to FIGS. 1 to 8, according to an example embodiment of the disclosure, a cleaning brush 001 comprises:
a head portion, comprising a brushing disc 1 and a housing 2 as a first part, a mounting portion 201 being provided on the housing 2,
a hand grip 3 as a second part, having a rotary portion 301 adapted to the mounting portion 201; and
a rotary locking assembly, comprising a sliding block 4 and a rotary drive element 5;
the rotary portion 301 is rotatably sleeving-fitted with the mounting portion 201, the sliding block 4 is mounted on the rotary portion 301, the rotary drive element 5 rotates to drive the sliding block 4 to move radially along the rotary portion 301 so as to lock the sliding block 4 to the mounting portion 201 or unlock the sliding block 4 from the mounting portion 201.

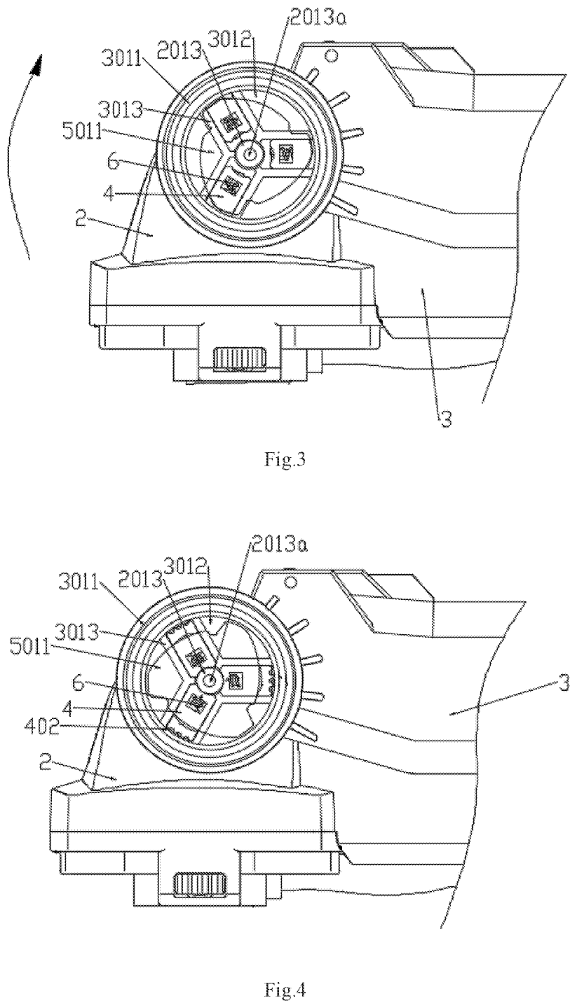

In this example embodiment, the head housing 2 as the first part and the hand grip 3 as the second part are rotatably sleeving-fitted, so that relative rotation is enabled therebetween to realize adjustment of their relative positions; in addition, the rotary locking assembly as provided locks them to their adjusted positions. In need of adjustment, the rotary drive element 5 is driven to rotate reversely to bring the sliding block 4 to move on the rotary portion 301 radially towards the center of the rotary portion 301, whereby the sliding block 4 is disengaged from the mounting portion 201 and unlocking is realized; after the first part rotates relative to the second part till an appropriate angle, the rotary drive element 5 is driven to rotate forwardly, bringing the sliding block 4 to move radially on the rotary portion 301 towards an edge of the rotary portion 301 to gradually approach to the mounting portion 201 till engaging the mounting portion 201 and being locked, whereby the first part and the second part are locked there; the arrow direction shown in FIG. 3 indicates the direction of reverse rotation.

The rotary mechanism in this example embodiment implements locking and unlocking at different positions via radial sliding of the sliding block 4 on the rotary portion 301; this simplifies the structure and facilitates operation; in addition, dependent on different use scenarios, muti-stage or even stepless adjustment of the relative positions between the first part and the second part is realized, so that the brushing disc 1 is more conformable with a to-be-cleaned surface, which also facilitates force application by hand, thereby enhancing cleaning effect and improving user experience.

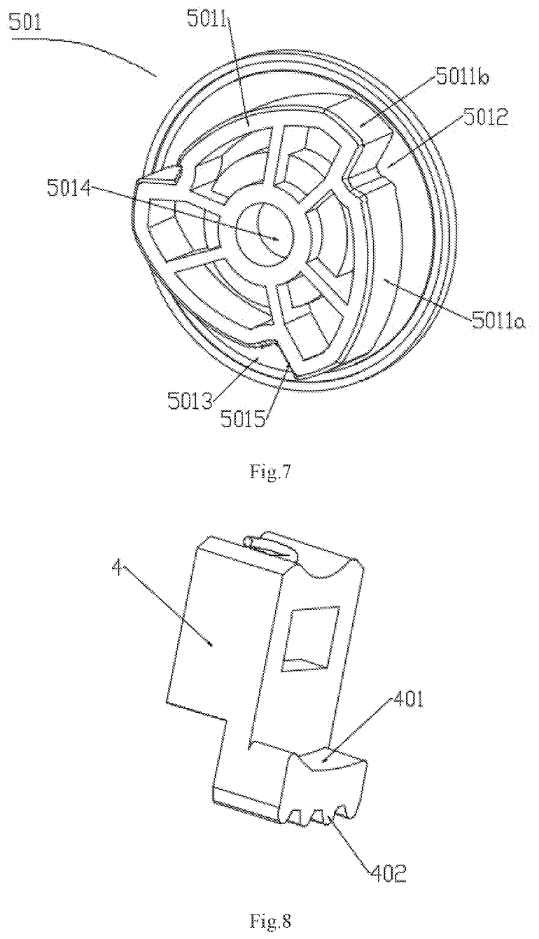

As illustrated in FIG. 5, FIG. 7, and FIG. 8, the rotary drive element 5 comprises a rotary cam 501 and a rotary flip lock lever 502 driving the rotary cam 501 to rotate; the rotary cam 501 comprises a faceplate 5013 and a convex rib 5011; a side surface of the convex rib 5011 forms a pushing surface 5011a that pushes the sliding block 4 to move; and a force-receiving surface 401 fitted with the pushing surface 5011a is provided on the sliding block 4. When the rotary drive element 5 rotates, the pushing surface 5011a applies a pushing force along the radial direction of the rotary portion 301 against the force-receiving surface 401; the force applied against the force-receiving surface 401 via the pushing surface 5011a drives the rotary drive element 5 to bring the sliding block 4 to move radially. In an implementation, the pushing surface 5011a has a gradually widened configuration on the rotary drive element 5 along a rotate-to-unlock direction, so that when the rotary drive element 5 rotates, the force-receiving surface 401 and the gradually widened configuration are sliding-fitted or rotating-fitted. With the gradually widened structural profile, when the rotary drive element 5 rotates forwardly, the force-receiving surface 401 slides on the pushing surface 5011a along the gradually widened direction, so that the pushing surface 5011a pushes the force-receiving surface 401 outwardly, driving the sliding block 4 to move towards the edge of the rotary portion 301 till being locked; and when the rotary drive element 5 rotates reversely, the force-receiving surface 401 slides on the pushing surface 5011a along a gradually narrowed direction, so that the pushing surface 5011a brings the force-receiving surface 401 to move inwardly, driving the sliding block 4 to move towards the center of the rotary portion 301 till being unlocked.

To realize continued locking between the sliding block 4 and the mounting portion 201, as illustrated in FIG. 7, the pushing surface 5011a extends out along the rotate-to-unlock direction to form a pressing surface 5011b in tight pressing-fit with the force-receiving surface 401, and a stopper for restraining a rotational travel of the pressing surface 5011b is provided along a rotate-to-lock direction on the force-receiving surface 401. When the rotary cam 501 rotates forwardly, the force-receiving surface 401 of the sliding block 4 slides along the gradually widened direction of the pushing surface 5011a till a position fitted with the pressing surface 5011b, so that the pressing surface 5011b presses against the force-receiving surface 401 to press the sliding block 4 securely against the mounting portion 201, without being unlocked during use; in addition, the stopper restrains movement of the pressing surface 5011b, preventing the pressing surface 5011b from moving further forward and thus preventing missing the force-receiving surface 401, so that the force-receiving surface 401 would not be disengaged from the convex rib 5011, and thus the sliding block 4 and the mounting portion 201 would not be unlocked. To ensure magnitude of the pressing force when the pressing surface 5011b and the force-receiving surface 401 rotate relative to each other, the pressing surface 5011b exemplarily has a planar or substantially planar profile, with an included angleαbeing formed between the pressing surface 5011b and a tangent line of the end portion of the pushing surface 5011a, where 30°≤α≤90°. Of course, an alternative limiting structure may also be utilized to restrain the rotational travel of the pressing surface 5011b, e.g., restraining the rotational travel of the pressing surface by fitting between a flip lock lever and a bump.

The structure noted supra enables conversion of rotation of the rotary cam 501 to radial movement of the sliding block 4 on the rotary portion via fitting between the convex rib 5011 and the sliding block 4; in addition, since the tangent line of the circumferential rotational trajectory of the convex rib 5011 at the position of the sliding block 4 is vertical to the radial direction, rotation of the convex rib 5011 can restrain radial movement of the sliding block 4, thereby realizing locking between the sliding block 4 and the mounting portion 201.

In some implementations, as illustrated in FIGS. 3, 4, and 7, at least three convex ribs 5011 are provided on the rotary cam 501, the at least three convex ribs 5011 being end-to-end connected via a vertical rib 5015 to form a closed loop, which realizes synchronous locking at multiple positions in the circumferential direction and renders more secure locking; in addition, end-to-end joints can also limit the relative sliding travel between the sliding block 4 and the convex ribs 5011. A notch 5012 is formed between a lower position of a preceding convex rib 5011 and the vertical rib 5015, so that when the rotary cam 501 rotates reversely, the sliding block 4 is disposed in the notch 5012 to thereby limit the reverse rotational travel; this arrangement enables the rotary drive element 5 and the hand grip 3 to be disposed in a relative stable state without relative rotation during adjustment of the housing 2 for unlocking purpose. Of course, the number of convex ribs can be four, five, or even more.

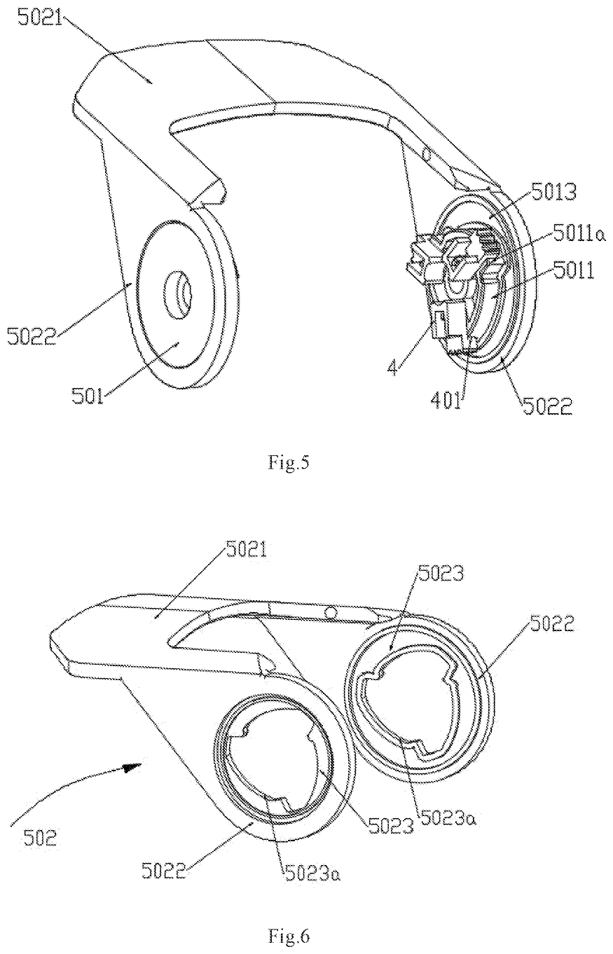

The rotary cam 501 and the rotary flip lock lever 502 may be discretely arranged; as illustrated in FIG. 6, the rotary flip lock lever 502 comprises a driver portion 5021 and a rotation-transmitting portion 5022 sleeved over the convex rib 5011; a transmission block 5023 is provided on the rotation-transmitting portion 5022, an inner side surface 5023a of the transmission block 5023 being agreeable with the outer side surface of the convex rib 5011 to realize fitting between the rotary flip lock lever 502 and the convex rib 5011; the driver portion 5021 pushes the rotary flip lock lever 502 to rotate, the rotation-transmitting portion 5022 transmits a rotational torque of the rotary flip lock lever 502 to the convex 5011 of the rotary cam 501 via the transmission block 5023, whereby the rotary cam 501 is brought to rotate; the rotary flip lock lever 502 facilitates force application by hand and rotational travel control. In some implementations, the driver portion 5021 selects a driver plate, and after the locking, the driver portion 5021 is caught on a surface of the hand grip 3.

Of course, the rotary cam and the rotary flip lock lever may be alternatively unitarily formed.

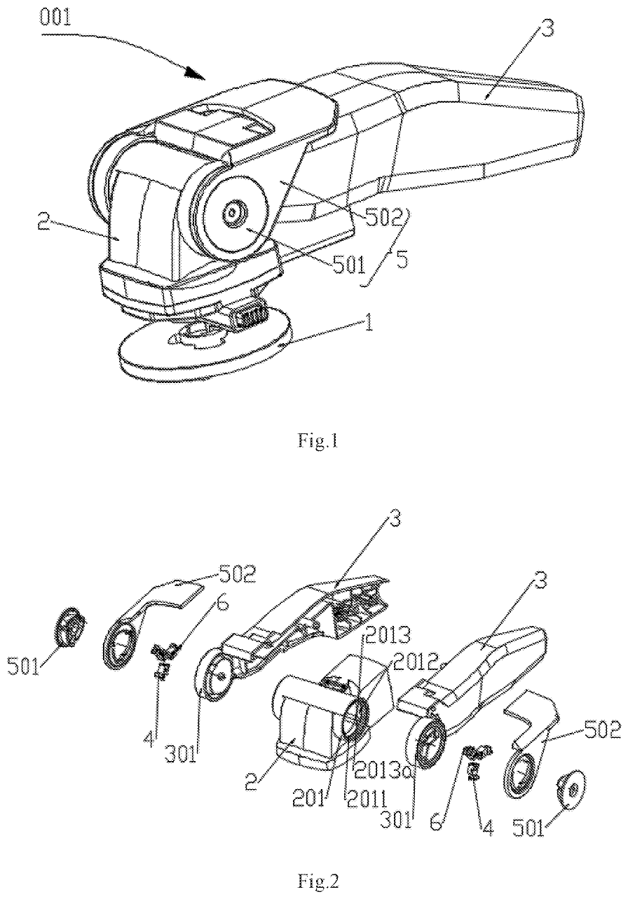

To achieve more secure mounting of the sliding block 4 on the rotary portion 301 and more stable and smoother sliding of the sliding blocker 4, as illustrated in FIGS. 2-4, an elastic reset element 6 is provided on the sliding block 4, so that in case of unlocking, the sliding block 4 is retracted towards the center of the mounting portion 201; when the rotary cam 501 rotates forwardly, the sliding block 4 moves towards the edge of the rotary portion 301, with the elastic reset element 6 being stretched in the meanwhile, so that when the rotary cam 501 rotates reversely, the elastic reset element 6 is reset gradually, and under the pulling force of the elastic reset element 6, the sliding block 4 moves towards the center of the rotary portion 301 till resuming its initial position. In this structure, an outer side surface of the convex rib 5011 forms an outer pushing surface 5011a, and it is only needed to provide an outer force-receiving surface 401 on the sliding block to push the sliding block 4 to move towards the edge of the mounting portion 201, thereby eliminating a drive structure additionally provided between the convex rib 5011 and the sliding block 4 to drive the sliding block 4 to move towards the center of the mounting portion 201, this simplifies the structure, eases operation, and also lowers manufacturing difficulty.

Of course, in some other example embodiments, a drive structure for driving the sliding block to move towards the center of the mounting portion may also be additionally provided between the convex rib and the sliding block, e.g., an inner side surface of the convex rib forms the inner pushing surface, and an inner force-receiving surface is additionally provided on the sliding block; as such, the inner pushing surface applies an inward pushing force against the inner force-receiving surface.

In this example embodiment, the sliding block 4 and the mounting portion 201 are locked by tooth-fitting. In some implementations, as illustrated in FIGS. 2 and 4, an inner gear ring 2011 is provided on the mounting portion 201, and outer teeth 402 meshed with the inner gear ring 2011 are provided on the sliding block 4; when the sliding block 4 moves radially towards the edge of the rotary portion 301, the outer teeth 402 are inserted into the valleys of the inner gear ring 2011 to realize locking: when the sliding block 4 moves radially towards the center of the rotary portion 301, the outer teeth 402 are disengaged from the valleys of the inner gear ring 2011 to realize unlocking; the outer teeth 402 of the sliding block 4 may be locked at any position of the inner gear ring 2011 to realize stepless adjustment between the first part and the second part; meanwhile, tooth-fitting locking is easily realized with a lower fitting precision requirement; in addition, mutual restraint between the plurality of teeth renders more secure locking.

Of course, in some other example embodiments, the sliding block and the mounting portion may also be locked via friction fitting or pin-hole fitting.

In this example embodiment, to ensure a balanced and stable operation, as illustrated in FIGS. 1 and 2, two mounting portions 201 are symmetrically provided at two sides of the housing 2; and correspondingly, two rotary portions 301 are also symmetrically provided on the hand grip 3, the rotary drive element 5 also comprises two rotary cams 501, and two rotation-transmitting portions 5022 fitted with the rotary cams 501 are provided at two sides of the driver plate of the rotary flip lock lever 502; the mounting portion 201 is of a cylindrical structure with an inner cavity 2012, with a mounting shaft 2013 provided in the center of the cylinder; the rotary portion 301 comprises an annular-shaped shroud 3011 sleeved over a cylindrical wall, a recessed groove 3012 being provided in the middle of the annular-shaped shroud 3011, the mounting shaft 2013 passing through the bottom wall of the recessed groove 3012; at least three guide rails 3013 extending from the middle of the recessed groove 3012 to the edge thereof are provided in the recessed groove 3012, the sliding blocks 4 being disposed in the guide rails 3013; holes for the sliding blocks 4 to pass through are provided at positions of an inner wall of the annular-shaped shroud 3011 corresponding to the guide rails 3013; securing blocks for securing an elastic connecting element are provided at positions in the guide rails 3013 proximal to the middle of the recessed groove 3012; a through hole 5014 fitted with the mounting shaft 2013 is also provided in the center of the rotary cam 501; a fastening hole 2013a is formed in the mounting shaft 2013, an outer side of the mounting shaft being fixed with a fastener; this structure formed by fitting between the fastener and the mounting shaft 2013 axially limits the shroud and the rotary cam 501.

An operation process of the cleaning brush 001 according to this example embodiment is described as such:

In need of adjusting the position of the brushing disc 1, the driver portion 5021 of the rotary flip lock lever 502 is driven to rotate reversely upward, so that the rotation-transmitting portion 5022 of the rotary flip lock lever 502 drives the rotary cam 501 to rotate reversely, bringing the convex rib 5011 to rotate reversely, which disengages the force-receiving surface 401 of the sliding block 4 from the pressing surface 5011b on the convex rib 5011 to realize unlocking, and under the action of the elastic reset element 6, the force-receiving surface 401 slides downward along the outer surface of the convex surface 5011 till into the notch 5012, and then by rotating the housing 2, the brushing disc 1 is moved for angle adjustment; after the adjustment is completed, the driver portion 5021 of the rotary flip lock lever 502 is driven to rotate forward downwardly, so that the rotation-transmitting portion 5022 of the rotary flip lock lever 502 drives the rotary cam 501 to rotate forwardly, bringing the convex rib 5011 to rotate forwardly, which results in upward sliding of the sliding block 4 along the outer side surface of the convex rib 5011 via the force-receiving surface 401 till a position fitted with the pressing surface 5011b, with the elastic reset member 6 being stretched in the meanwhile, and the pressing surface 5011b presses against the force-receiving surface 401 such that the sliding block 4 stably and tightly abuts against the mounting portion 201 to be locked; now, the driver portion 5021 is caught on the hand grip 3, which enhances locking stability and preventing unintentional unlocking if the driver portion 5021 is accidentally knocked during use.

What have been described above are only embodiments of the disclosure; however, the protection scope of the disclosure is not limited thereto. A person skilled in the art should understand that the disclosure includes, but is not limited to, the contents described in the drawings and the embodiments. Any modifications without departing from the functions and structural principles of the disclosure will be included within the scope of the claims.

1. A rotary mechanism, comprising a first part, a second part, and a rotary locking assembly, a mounting portion being provided on the first part, the second part having a rotary portion adapted to the mounting portion, wherein the rotary portion and the mounting portion are rotatably sleeving-fitted, the rotary locking assembly comprises a sliding block and a rotary drive element, the sliding block is mounted on the rotary portion, and the rotary drive element rotates to bring the sliding block to move radially along the rotary portion so that the sliding block is locked on the mounting portion or is unlocked from the mounting portion.

2. The rotary mechanism according to claim 1, wherein an inner gear ring is provided on the mounting portion, and outer teeth meshed with the inner gear ring are provided on the sliding block; or, the sliding block and the mounting portion are locked via friction fitting or pin-hole fitting.

3. The rotary mechanism according to claim 1, wherein a pushing surface is provided on the rotary drive element, and a force-receiving surface fitted with the pushing surface is provided on the sliding block, so that when the rotary drive element rotates, the pushing surface applies a pushing force against the force-receiving surface along a radial direction of the rotary portion.

4. The rotary mechanism according to claim 3, wherein the pushing surface has a gradually widened configuration on the rotary drive element along a rotate-to-unlock direction, so that when the rotary drive element rotates, the force-receiving surface is sliding-fitted or rolling-fitted with the gradually widened configuration; and/or, the pushing surface extends out along the rotate-to-unlock direction to form a pressing surface in tight pressing-fit with the force-receiving surface.

5. The rotary mechanism according to claim 4, wherein a stopper configured to limit a rotational travel of the pressing surface is provided along a rotate-to-lock direction on the force-receiving surface; or, the rotational travel of the pressing surface is limited by fitting between a flip lock lever and a bump.

6. The rotary mechanism according to claim 1, wherein the rotary drive element comprises a rotary cam, a convex rib being provided on the rotary cam, a side surface of the convex rib being formed as a pushing surface for pushing the sliding block; and/or, an elastic reset element is provided on the sliding block so that when unlocking, the sliding block is retracted towards the center of the mounting portion.

7. The rotary mechanism according to claim 6, wherein at least three convex ribs are provided on the rotary cam, the at least three convex ribs being end-to-end connected to form a closed loop.

8. The rotary mechanism according to claim 6, wherein the rotary drive element further comprises a rotary flip lock lever sleeved over the rotary cam, the rotary flip lock lever driving the rotary cam to rotate.

9. The rotary mechanism according to claim 8, wherein the rotary flip lock lever comprises a driver portion and a rotation-transmitting portion sleeved over the convex rib, and a transmission block is provided on the rotation-transmitting portion, an inner side surface of the transmission block being agreeable with an outer side surface of the convex rib.

10. A handheld tool, comprising the rotary mechanism according to claim 1.
